(19) United States
(12) Patent Application Publication
(10) Pub. No.: US 2022/0002590 A1
(43) Pub. Date: Jan. 6, 2022

(54) Cyanoacrylate Adhesive Composition

(71) Applicant: Henkel AG & Co. KGaA, Duesseldorf (DE)

(72) Inventors: Zuohe Wang, Shanghai (CN); Heqiang Zhang, Shanghai (CN); Chongjian Song, Shanghai (CN)

(21) Appl. No.: 17/481,540

(22) Filed: Sep. 22, 2021

Related U.S. Application Data
(63) Continuation of application No. PCT/CN2019/079170, filed on Mar. 22, 2019.

(51) Int. Cl. C09J 4/00; C08F 222/32; C08K 5/00; C08K 5/315

(52) U.S. Cl. CPC C09J 4/00; C08F 222/322; C09J 2301/30; C08K 5/315; C08K 5/005

(57) ABSTRACT

The present invention provides a cyanoacrylate adhesive composition comprising: (A) a cyanoacrylate component, and (B) a β,β-diaryl-α-cyanoacrylate-based light stabilizer; cured product of the composition according to the present invention, and a method of bonding together two substrates using the cyanoacrylate adhesive composition according to the present invention.

### TECHNICAL FIELD

The present invention relates to a cyanoacrylate adhesive composition, in particular to a cyanoacrylate adhesive composition containing a β,β-diaryl-α-cyanoacrylate-based light stabilizer.

### BACKGROUND OF THE INVENTION

Cyanoacrylate adhesives are well-known instantaneous adhesives and are widely used in various industrial fields such as electronic, electric and automotive fields and in leisure and household applications, and they are polymerized and hardened in a short time to bond various materials to each other.

Traditional cyanoacrylate adhesives show poor storage stability under light exposure (including sunlight and UV light). The viscosity of the adhesive increases significantly after around one-month outdoor storage in regular transparent/translucent packages. The increase of viscosity leads to poor storage stability, which in turn affects the shelf life of cyanoacrylate adhesives. Usually, introducing light stabilizer(s) can lead to deterioration of thermal stability of the adhesives.

Therefore, to develop a cyanoacrylate adhesive having good storage stability, especially having both light stability and thermal stability, is desirable.

### SUMMARY OF THE INVENTION

It is an object of the present invention to solve the above-mention problem, that is, to provide a cyanoacrylate adhesive composition having good storage stability, especially having both light stability and thermal stability.

After intensive studies, the inventors have found that the problem can be solved by selecting a specific light stabilizer, that is, by incorporation of a β,β-diaryl-α-cyanoacrylate-based light stabilizer, storage stability can be improved. Thereby, the present invention provides a cyanoacrylate adhesive composition, comprising or consisting essentially of: (A) a cyanoacrylate component, and (B) a β,β-diaryl-α-cyanoacrylate-based light stabilizer.

The cyanoacrylate adhesive composition according to the present invention shows good light stability as well as good thermal stability.

In another aspect of the present invention, provided is a method of bonding together two substrates, the method including applying the cyanoacrylate adhesive composition according to the present invention to at least one of the substrates and then mating together the substrates.

In addition, the present invention is also directed to reaction products of the cyanoacrylate adhesive composition according to the present invention.

### DETAILED DESCRIPTION OF THE INVENTION

It is to be understood by one of ordinary skill in the art that the present invention is a description of exemplary embodiments only, and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, all wt % or % by weight values quoted herein are percentages by weight based on total weight of the cyanoacrylate adhesive composition.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “consisting essentially of” as used herein means that the listed components constitute main body of the composition, for example, at least 80% by weight of the composition, at least 83% by weight of the composition, at least 85% by weight of the composition, or at least 90% by weight of the composition.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

According to the present invention, the cyanoacrylate adhesive composition comprises or consists essentially of: (A) a cyanoacrylate component, and (B) a ββ-diaryl-α-cyanoacrylate-based light stabilizer.

(A) Cyanoacrylate component

The cyanoacrylate component (A) used in the present invention can be any conventionally used cyanoacrylates in the art, for example, those represented by the following structure:

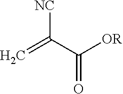

wherein R is selected from C1-C15 alkyl group, such as methyl, ethyl, propyl, butyl, amyl, hexyl, heptyl, octyl, nonyl, decyl, undecyl; C2-C15 alkoxyalkyl group, such as methoxyethyl, ethoxyethyl, methoxypropyl, butoxylmethyl; C3-C15 cycloalkyl group, such as cyclohexyl; C2-C15 alkenyl group, such as vinyl, propenyl; C7-C15 aralkyl, C6-C15 aryl, allyl and C1-C15 haloalkyl groups.

Examples of the cyanoacrylate component includes but not limited to 2-cyanoacrylates, especially, methyl-2-cyanoacrylate, ethyl-2-cyanoacrylate, propyl-2-cyanoacrylate, isopropyl-2-cyanoacrylate, n-butyl-2-cyanoacrylate, isobutyl-2-cyanoacrylate, amyl-2-cyanoacrylate, hexyl-2-cyanoacrylate, cyclohexyl-2-cyanoacrylate, octyl-2-cyanoacrylate, 2-ethylhexyl-2-cyanoacrylate, allyl-2-cyanoacrylate, benzyl-2-cyanoacrylate, methoxyethyl-2-cyanoacrylate, ethoxyethyl-2-cyanoacrylate, methoxypropyl-2-cyanoacrylate, tetrahydrofurfuryl-2-cyanoacrylate, and the like. A particularly desirable one is ethyl-2-cyanoacrylate.

The cyanoacrylate component (A) may comprise one or more cyanoacrylates described above.

The cyanoacrylate component (A) constitutes the main body of the adhesive composition, and may be comprised in the composition in an amount of at least 80% by weight, at least 85% by weight, at least 90% by weight, such as 88% by weight, 95% by weight, 97% by weight, 98% by weight, 99% by weight, 99.5% by weight, 99.8% by weight, 99.9% by weight, each based on total weight of the adhesive composition.

(B) ββ-diaryl-α-cyanoacrylate-based Light Stabilizer

Any known ββ-diaryl-α-cyanoacrylate-based light stabilizers can be used in the present invention. Preferably, the β,β-diaryl-α-cyanoacrylate-based light stabilizer used in the present invention comprises a moiety represented by structure (I):

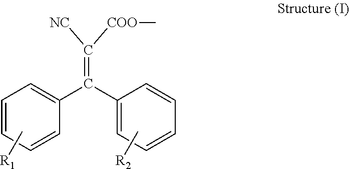

wherein R₁ represents one or more substituents on the benzene ring, such as one, two, three, four or five substituents; and Ri, independently of each other, is selected from hydrogen, C₁-C₄-alkyl group, C₁-C₄-alkoxy group, or di(C₁-C₄-alkyl)amino group; for example, methyl, ethyl, methoxy, ethoxy and dimethylamino groups, and

R₂ represents one or more substituents on the benzene ring, such as one, two, three, four or five substituents; and R₂, independently of each other, is selected from hydrogen, C₁-C₄-alkyl group, C₁-C₄-alkoxy group, or di(C₁-C₄-alkyl)amino group; for example, methyl, ethyl, methoxy, ethoxy and dimethylamino groups.

Preferably, the β,β-diaryl-α-cyanoacrylate-based light stabilizer used in the present invention comprises a moiety represented by structure (II):

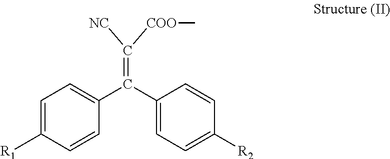

wherein R₁ is selected from hydrogen, C₁-C₄-alkyl group, C₁-C₄-alkoxy group, or di(C₁-C₄-alkyl)amino group; for example, methyl, ethyl, methoxy, ethoxy and dimethylamino groups, and

R₂ is selected from hydrogen, C₁-C₄-alkyl group, C₁-C₄-alkoxy group, or di(C₁-C₄-alkyl)amino group; for example, methyl, ethyl, methoxy, ethoxy and dimethylamino groups.

In particular, the β,β-diaryl-α-cyanoacrylate-based light stabilizer used in the present invention is represented by the structure (III):

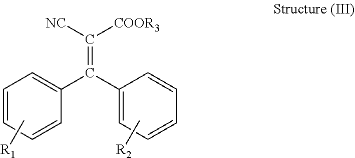

wherein R₁ and R₂ have the same definitions as those defined in Structure (I); and R₃ is a C₁-C₁₈-alkyl group which can be interrupted by an oxygen atom, for example, C₁-C₁₆-alkyl group, C₁-C₁₂-alkyl group, C₁-C₁₀-alkyl group, C₁-C₈-alkyl group, such as, methyl group, ethyl group, propyl group, butyl group, amyl group, hexyl group, 2-ethylhexyl group and the like.

Preferably, the β,β-diaryl-α-cyanoacrylate-based light stabilizer used in the present invention is represented by the structure (IV):

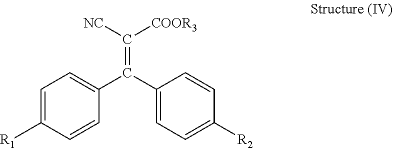

wherein R₁ and R₂ have the same definitions as those defined in Structure (II); and R₃ has the same definitions as those defined in Structure (III).

The composition of the present invention may comprise one or more β,β-diaryl-α-cyanoacrylate-based light stabilizers described above.

The β,β-diaryl-α-cyanoacrylate-based light stabilizer used in the present invention may be comprised in the composition in an amount of no more than 10% by weight, no more than 8% by weight, no more than 6% by weight, or no more than 5% by weight, and no less than 0.005% by weight, no less than 0.01% by weight, no less than 0.02% by weight, no less than 0.03% by weight, no less than 0.04% by weight, no less than 0.05% by weight, such as 0.015% by weight, 0.018% by weight, 0.021% by weight, 0.025% by weight, 0.028% by weight, 0.05% by weight, 0.1% by weight, 0.2% by weight, 1% by weight, 2% by weight, 3% by weight, 4% by weight, each based on total weight of the adhesive composition.

The β,β-diaryl-α-cyanoacrylate-based light stabilizer used in the present invention may be comprised in the composition in an amount of no less than 0.005 parts by weight, no less than 0.01 parts by weight, such as 0.02 parts by weight, 0.03 parts by weight, 0.04 parts by weight, 0.05 parts by weight, 0.06 parts by weight, 0.07 parts by weight, 0.08 parts by weight, 0.09 parts by weight, 0.1 parts by weight, 0.2 parts by weight, 0.3 parts by weight, 0.5 parts by weight, 1 parts by weight, and no more than 10 parts by weight, such as 2 parts by weight, 3 parts by weight, 4 parts by weight, 5 parts by weight, 6 parts by weight, 7 parts by weight, 8 parts by weight, each based on 100 parts by weight of the cyanoacrylate component.

The β,β-diaryl-α-cyanoacrylate-based light stabilizer used in the present invention can be synthesized through known methods, for examples, reacting a benzophenone imine of the general Formula A with a cyanoacetic ester of the general Formula B:

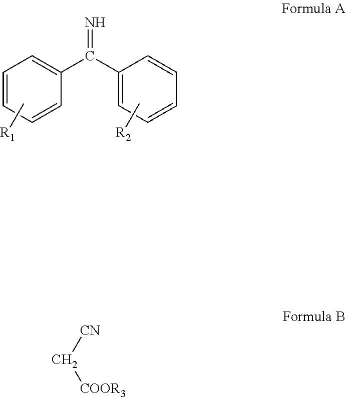

wherein R¹, R² and R³ have the same definitions as those defined above in Structure (III).

The β,β-diaryl-α-cyanoacrylate-based light stabilizer used in the present invention can be commercially available, for example, from BASF under the tradenames Uvinul® 3035, Uvinul® 3039, and Uvinul® 3030.

### Additional Components

In addition to the cyanoacrylate component (A) and the β, β-diaryl-α-cyanoacrylate-based light stabilizer (B), the cyanoacrylate adhesive composition of the present invention may further optionally comprise additional components, which will be described as below.

### Acid Stabilizer Compound

The acid stabilizer compound is an inhibitor of anionic polymerization in the composition of the invention and is selected from the group of Lewis acids. One or more of such stabilizing agents can be used.

The one or more acid stabilizing agents can be selected for example from the group consisting of boron trifluoride, boron trifluoride etherate complex, boron trifluoride dihydrate, trimethylsilyl triflate, sulphur dioxide, methanesulfonic acid, and mixtures thereof, more preferably from boron trifluoride etherate complex and boron trifluoride dihydrate.

In the composition, the content of the acid stabilizer with respect to the pure Lewis acid (not complexed), for example BF₃, is generally comprised between 0.0001% and 0.0050% by weight, equivalent to 1 ppm and 50 ppm respectively, preferably 1 ppm to 40 ppm, more preferably 1 ppm to 30 ppm, such as 2 ppm, 4 ppm, 6 ppm, 8 ppm, 10 ppm, 12 ppm, 14 ppm, 16 ppm, 18 ppm, 20 ppm, 22 ppm, 24 ppm, 26 ppm, 28 ppm, 32 ppm, 34 ppm, 36 ppm, 38 ppm, each based on the weight of the composition.

### Accelerators

The cyanoacrylate composition of the present invention may comprise one or more accelerators, such as those selected from calixarenes and oxacalixarenes, silacrowns, crown ethers, cyclodextrins, polyethyleneglycol di(meth)acrylates, ethoxylated hydric compounds and combinations thereof.

Of the calixarenes and oxacalixarenes, many are known, and are reported in the patent literature. See e.g., U.S. Pat. Nos. 4,556,700, 4,622,414, 4,636,539, 4,695,615, 4,718,966, and 4,855,461, the disclosures of each of which are hereby expressly incorporated herein by reference.

For instance, as regards calixarenes, those within the following structure are useful herein:

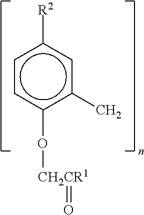

where R¹ is alkyl, alkoxy, substituted alkyl or substituted alkoxy; R² is H or alkyl; and n is 4, 6 or 8.

One particularly desirable calixarene is tetrabutyl tetra[2-ethoxy-2-oxoethoxy]calix-4-arene.

A host of crown ethers are known. For instance, any one or more of 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4,1,2-decalyl-15-crown-5,1,2-naphtho-15-crown-5,3,4,5-naphtyl-16-crown-5, 1.2-methyl-benzo-18-crown-6, 1.2-methylbenzo-5,6-methylbenzo-18-crown-6,8-crown-6, 1,2-vinylbenzo-15-crown-5,1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7 may be used. See U.S. Pat. No. 4,837,260 (Sato), the disclosure of which is hereby expressly incorporated herein by reference.

Of the silacrowns, again many are known, and are reported in the literature. Specific examples of silacrown compounds useful in the inventive compositions include dimethylsila-11-crown-4, dimethylsila-14-crown-5, and dimethylsila-17-crown-6. See e.g., U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Wenz), the disclosure of which is hereby expressly incorporated herein by reference.

For instance, poly(ethylene glycol) di(meth)acrylates suitable for use herein include those within the following Structure:

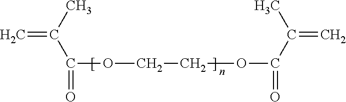

where n is greater than 3, such as within the range of 3 to 12, with n being 9 as particularly desirable. More specific examples include PEG 200 DMA (where n is about 4), PEG 400 DMA (where n is about 9), PEG 600 DMA (where n is about 14), and PEG 800 DMA, (where n is about 19), where the number (e.g., 400) represents the average molecular weight of the glycol portion of the molecule, excluding the two methacrylate groups, expressed as grams/mole (i.e., 400 g/mol).

Of the ethoxylated hydric compounds (or ethoxylated fatty alcohols that may be employed), appropriate ones may be chosen from those within the following Structure:

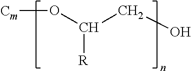

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁-6 alkyl.

In the composition of the invention, if present, the amount of the accelerator is preferably 50 ppm by weight to 5.0% by weight, further preferably 100 ppm by weight to 2.0% by weight, each based on the total weigh of the composition.

### Thickeners

A thickener serves to modulate the viscosity of formulations. Suitable thickening agents that can be used in the present invention include but not limited to poly(meth)acrylates, acylated cellulose polymers such as cellulose acetate and cellulose acetate propionate, polyvinyl acetates, partially hydrolysed polyvinyl acetates, polyvinylpyrrolidones, polyoxylates, polycaprolactones, polycyanoacrylates, vinyl acetate copolymers, copolymers of (meth)acrylates with butadiene and styrene, copolymers of vinyl chloride and acrylonitrile, copolymers of ethylene and vinyl acetate, and copolymers of lactic acid, caprolactone, and mixtures of two or more thereof.

Preferably, the thickener used in the present invention is selected from the group consisting of poly(meth)acrylates, polycyanoacrylates, polyvinylpyrrolidones, polyvinyl acetates, partially hydrolysed polyvinyl acetates, vinyl acetate copolymers, ethylene-vinyl acetate copolymers, ethylene-vinyl acetate-maleic acid/ester terpolymers, vinyl chloride-vinyl acetate copolymers, acylated cellulose polymers, and mixtures of two or more thereof.

In the composition of the invention, if present, the thickener, for examples polymethylmethacrylate, is usually present in a percentage of between 0.1% to 15% by weight, such as, 2% by weight, 3% by weight, 4% by weight, 5% by weight, 6% by weight, 7% by weight, 8% by weight, 9% by weight, 10% by weight, 11% by weight, 12% by weight, 13% by weight and 14% by weight, each based on the total weigh of the composition.

### Thermal Degradation Inhibitors

In order to improve the thermal stability of cured adhesive, one or more thermal degradation inhibitors can be added. The thermal degradation inhibitors used in the present invention are not particularly limited as long as they can improve or maintain the thermal stability of the cured adhesive. Examples of which include but not limited to hydrogenated anhydrides and benzonitriles. The hydrogenated anhydrides can be hydrogenated phthalic anhydride, such as 3, 4, 5, 6-tetrahydrophthalic anhydride; and isomeric versions thereof and partially hydrogenated versions of phthalic anhydride may also be used. The benzonitriles can be selected from mono-, poly- or hetero-aromatic compounds characterized by at least three substitutions on an aromatic ring thereof, with two or more of the substitutions being election withdrawing groups. Specific examples of such benzonitriles include 3,5-dinitrobenzonitrile; 2-chloro-3,5-dinitrobenzonitrile; pentafluorobenzonitrile; α,α,α-2-tetrafluoro-p-tolunitrile; and tetrachloroterephthalonitrile.

In the composition of the invention, if present, the one or more thermal degradation inhibitors is/are usually present in a percentage of between 0.1% to 5% by weight, such as, 0.2% by weight, 0.3% by weight, 0.4% by weight, 0.5% by weight, 0.6% by weight, 0.7% by weight, 0.8% by weight, 0.9% by weight, 1.0% by weight, 2.0% by weight, 3.0% by weight, and 4.0% by weight, each based on the total weigh of the composition.

In addition, the cyanoacrylate adhesive composition of the present invention may contain further one or more additives that are usually used in the cyanoacrylate adhesive composition, such as, plasticizers, accelerators, fillers, opacifiers, surface-insensitive additives, toughening agents, inhibitors, thixotropy conferring agents, dyes and the like.

In another aspect of the invention, there is provided a method of bonding together two substrates, the method including applying the cyanoacrylate adhesive composition according to the present invention to at least one of the substrates and then mating together the substrates for a time sufficient to permit the adhesive to fixture.

In yet another aspect of the invention, there is provided reaction products of the cyanoacrylate adhesive composition according to the present invention.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

Ethyl CA: ethyl-2-cyanoacrylate;

Uvinul 3035: a β,β-diaryl-α-cyanoacrylate-based light stabilizer having a structure of:

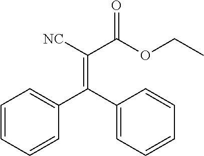 [SMILES: CCOC(=O)C(C#N)=C(c1ccccc1)c1ccccc1]

Uvinul 3039: a β,β-diaryl-α-cyanoacrylate-based light stabilizer having a structure of:

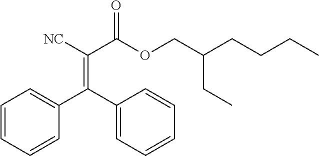 [SMILES: CCCCC(CC)COC(=O)C(C#N)=C(c1ccccc1)c1ccccc1]

Uvinul 3008: a benzophenone-based light stabilizer having a structure of:

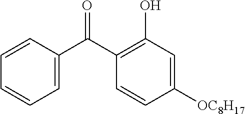

Uvinul 3028: a benzotriazole-based light stabilizer having a structure of:

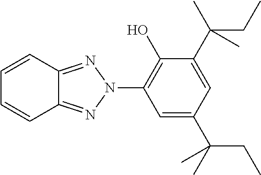 [SMILES: CCC(C)(C)c1cc(-n2nc3ccccc3n2)c(O)c(C(C)(C)CC)c1]

### Viscosity Test Method:

For the viscosity of no more than 10 mPa*s:

Each of the prepared compositions was allowed to stand for 24 hours in a constant-temperature chamber at 25° C., and the viscosity was then measured at a speed of 3000 S⁻¹ at 25° C. using a viscometer with CP60-0.5/TI cone plate (product name: MCR₁₀₂, manufactured by Anton Paar Co., Ltd.).

For the viscosity of higher than 10 mPa*s but no more than 1000 mPa*s:

Each of the prepared compositions was allowed to stand for 24 hours in a constant-temperature chamber at 25° C., and the viscosity was then measured at a speed of 3000 S⁻¹ at 25° C. using a viscometer with CP50-1 cone plate (product name: MCR₁₀₂, manufactured by Anton Paar Co., Ltd.).

For the viscosity of higher than 1000 mPa*s:

Each of the prepared compositions was allowed to stand for 24 hours in a constant-temperature chamber at 25° C., and the viscosity was then measured at a speed of 100 S⁻¹ at 25° C. using a viscometer with CP50-1 cone plate (product name: MCR₁₀₂, manufactured by Anton Paar Co., Ltd.).

82° C./10 days test

The thermal stability test was conducted at 82° C. for 10 days. Specifically, 20 g of prepared composition were filled into a 25 mL high-density polyethylene (HDPE) bottle. The filled HDPE bottle then was heated in a constant-temperature chamber at 82° C. for 10 days. Then the viscosity of aged composition was measured according to the method mentioned previously.

### Q-Sun/24 hrs Test

The light stability test was conducted in Q-sun Xenon Test Chamber (Model Xe-3) manufactured by Q-lab Corporation, according to ASTM D4459 (Standard Practice for Xenon-Arc Exposure of Plastics Intended for Indoor Applications).

Specifically, 20 g of prepared composition were filled into a 25 mL high-density polyethylene (HDPE) bottle. The filled HDPE bottle then was aged in the Xenon Test Chamber for 24 hours. The wavelength of UV sensor in the chamber is 420 nm. The air temperature was 40° C., and the temperature of black panel was 55° C. The relative humidity was 55%. The irradiance was 0.8 W/m².

### Examples 1 to 6 and Comparative Examples 1 to 2c

To 100 parts by weight of ethyl-2-cyanoacrylate stabilized with 5ppm boron trifluoride, an amount of the light stabilizer in parts by weight as listed in Table 1 was added to prepare each adhesive composition. The results of evaluations described above are shown in Table 1.

TABLE 1

| | | | | | | Viscosity, mPa · s | | |
|---|---|---|---|---|---|---|---|---|
| | | Uvinul | Uvinul | Uvinul | Uvinul | | 82° C. | Q-sun |
| | Ethyl CA | 3035 | 3039 | 3008 | 3028 | Initial | 10 D | 24 hrs |
| Ex. 1 | 100 | 0.01 | — | — | — | 1.98 | 4.6 | 15 |
| Ex. 2 | 100 | 0.05 | — | — | — | 1.95 | 4.9 | 9 |
| Ex. 3 | 100 | 0.1 | — | — | — | 1.98 | 5.2 | 7.6 |
| Ex. 4 | 100 | — | 0.01 | — | — | 1.98 | 4.7 | 34 |
| Ex. 5 | 100 | — | 0.05 | — | — | 1.98 | 5.2 | 16 |
| Ex. 6 | 100 | — | 0.1 | — | — | 1.98 | 6.6 | 7.3 |
| Com. Ex. 1 | 100 | — | — | — | — | 1.95 | 4.6 | Gel |
| Com. Ex. 2a | 100 | — | — | 0.01 | — | 1.98 | 9 | 33 |
| Com. Ex. 2b | 100 | — | — | 0.05 | — | 1.98 | 59 | 9.6 |
| Com. Ex. 2c | 100 | — | — | 0.1 | — | 1.98 | 102 | 6.8 |

It can be seen from Table 1 that, in the 82° C./10 days test, compared with the comparative light stabilizer, the β,β-diaryl-α-cyanoacrylate-based light stabilizer of the present invention led to small viscosity increase with the addition amount increased. In other words, compared with the comparative light stabilizer, there is only small change on the thermal stability when the addition amount of the β,β-diaryl-α-cyanoacrylate-based light stabilizer increases. Meanwhile, when comprised in the same level, in the 82° C./10 days test, the β,β-diaryl-α-cyanoacrylate-based light stabilizer of the present invention achieved significantly low viscosity compared with the comparative light stabilizer; taking 0.01 parts by weight of the light stabilizer as an example, Examples 1 and 2 showed a final viscosity of 4.6 mPa.s and 4.7 mPa.s; while Comparative Example 2a showed a final viscosity of 9 mPa.s. In the Q-sun/24 hrs test, the β,β-diaryl-α-cyanoacrylate-based light stabilizers achieved comparable light stability to the comparative light stabilizer. Therefore, using the β,β-diaryl-α-cyanoacrylate-based light stabilizer of the present invention in combination with the cyanoacrylate significantly improves the thermal stability of the adhesive while maintaining the light stability, thereby the storage stability can be improved.

### Examples 7 to 12 and Comparative Examples 3 to 5c

To 100 parts by weight of a cyanoacrylate formulation stated as below, an amount of the light stabilizer in parts by weight as listed in Table 2 was added to prepare each adhesive composition. The results of evaluations described above are shown in Table 2.

The cvanoacrvlate formulation:

| | Amount | |
|---|---|---|
| Ethyl 2-Cyanoacrylate | 92.8 | parts by weight |
| BF₃ (ppm) | 10 | ppm |
| Polymethyl methacrylate | 6.5 | parts by weight |
| Dibenzo-18-Crown-6 | 0.1 | parts by weight |
| Pentafluorobenzonitrile | 0.5 | parts by weight |
| Tetrahydrophthalic anhydride | 0.1 | parts by weight |

TABLE 2

| | Cyanoacrylate | | | | | Viscosity, mPa · s | | |
|---|---|---|---|---|---|---|---|---|
| | formulation as | Uvinul | Uvinul | Uvinul | Uvinul | | 82° C. | Q-sun |
| | stated above | 3035 | 3039 | 3008 | 3028 | Initial | 10 D | 24 hrs |
| Ex. 7 | 100 | 0.01 | — | — | — | 93 | 334 | 265 |
| Ex. 8 | 100 | 0.05 | — | — | — | 93 | 370 | 219 |
| Ex. 9 | 100 | 0.1 | — | — | — | 93 | 393 | 162 |
| Ex. 10 | 100 | — | 0.01 | — | — | 93 | 348 | 303 |
| Ex. 11 | 100 | — | 0.05 | — | — | 93 | 387 | 264 |
| Ex. 12 | 100 | — | 0.1 | — | — | 93 | 402 | 201 |
| Com. Ex. 3 | 100 | — | — | — | — | 93 | 339 | 16800 |
| Com. Ex. 4a | 100 | — | — | 0.01 | — | 93 | 1350 | 1310 |
| Com. Ex. 4b | 100 | — | — | 0.05 | — | 93 | 1650 | 852 |
| Com. Ex. 4c | 100 | — | — | 0.1 | — | 93 | 2600 | 643 |
| Com. Ex. 5a | 100 | — | — | — | 0.01 | 93 | 530 | 218 |
| Com. Ex. 5b | 100 | — | — | — | 0.05 | 93 | 587 | 179 |
| Com. Ex. 5c | 100 | — | — | — | 0.1 | 93 | 612 | 138 |

It can be seen from Table 2 that, in the 82° C./10 days test, an amount of 0.01 parts by weight of the comparative light stabilizer led to significant increase of the final viscosity; while introducing the same amount of the β,β-diaryl-α-cyanoacrylate-based light stabilizer of the present invention kept the final viscosity in a relatively low level. In the Q-sun/24 hrs test, the β,β-diaryl-α-cyanoacrylate-based light stabilizers achieved comparable light stability to comparative light stabilizers. Therefore, introducing the β,β-diaryl-α-cyanoacrylate-based light stabilizer of the present invention to the cyanoacrylate adhesive composition significantly improves the thermal stability of the adhesive composition while maintaining the light stability, thereby the storage stability of the adhesive composition can be improved.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A cyanoacrylate adhesive composition, comprising:
(A) a cyanoacrylate component, and
(B) a β,β-diaryl-α-cyanoacrylate-based light stabilizer.

2. The composition according to claim 1, wherein the cyanoacrylate component comprises one or more cyanoacrylates represented by the following structure: 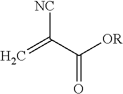
wherein R is selected from C1-C₁₅ alkyl group; C₂-C15 alkoxyalkyl group; C3-C15 cycloalkyl group; C2-C15 alkenyl group; C7-C15 aralkyl, C6-C15 aryl, allyl and C1-C15 haloalkyl groups.

3. The composition according to claim 1, wherein the cyanoacrylate component is selected from the group consisting of methyl-2-cyanoacrylate, ethyl-2-cyanoacrylate, propyl-2-cyanoacrylate, isopropyl-2-cyanoacrylate, n-butyl-2-cyanoacrylate, isobutyl-2-cyanoacrylate, amyl-2-cyanoacrylate, hexyl-2-cyanoacrylate, cyclohexyl-2-cyanoacrylate, octyl-2-cyanoacrylate, 2-ethylhexyl-2-cyanoacrylate, allyl-2-cyanoacrylate, benzyl-2-cyanoacrylate, methoxyethyl-2-cyanoacrylate, ethoxyethyl-2-cyanoacrylate, methoxypropyl-2-cyanoacrylate, tetrahydrofurfuryl-2-cyanoacrylate, and mixtures of two or more thereof.

4. The composition according to claim 1, wherein the cyanoacrylate component is present in an amount of at least 80% by weight, at least 85% by weight, at least 90% by weight, each based on total weight of the adhesive composition.

5. The composition according to claim 1, wherein the β,β-diaryl-α-cyanoacrylate-based light stabilizer comprises a moiety represented by structure (I): 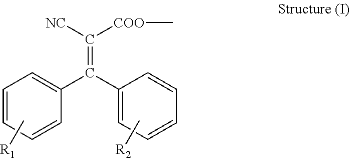
wherein
R₁ represents one or more substituents on the benzene ring; and R₁, independently of each other, is selected from hydrogen, C₁-C₄-alkyl group, C₁-C₄-alkoxy group, or di(C₁-C₄-alkyl)amino group; and
R₂ represents one or more substituents on the benzene ring; and R₂, independently of each other, is selected from hydrogen, C₁-C₄-alkyl group, C₁-C₄-alkoxy group, or di(C₁-C₄-alkyl)amino group.

6. The composition according to claim 1, wherein the β,β-diaryl-α-cyanoacrylate-based light stabilizer comprises a moiety represented by structure (II): 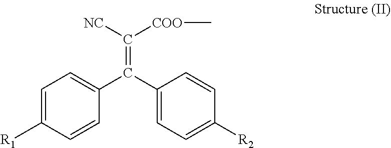
wherein
R₁ is selected from hydrogen, C₁-C₄-alkyl group, C₁-C₄-alkoxy group, or di(C₁-C₄-alkyl)amino group; and
R₂ is selected from hydrogen, C₁-C₄-alkyl group, CI-C₄-alkoxy group, or di(C₁-C₄-alkyl)amino group.

7. The composition according to claim 1, wherein the β,β-diaryl-α-cyanoacrylate-based light stabilizer is represented by the structure (III): 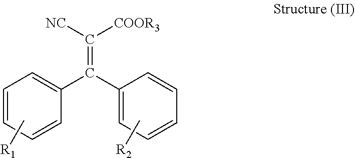
wherein R₁ and R₂ have the same definitions as those defined in Structure (I); and
R₃ is a C₁-C₁₈-alkyl group which can be interrupted by an oxygen atom.

8. The composition according to claim 1, wherein the β,β-diaryl-α-cyanoacrylate-based light stabilizer is represented by the structure (IV): 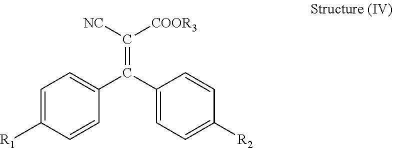
wherein R₁ and R₂ have the same definitions as those defined in Structure (II); and
R₃ has the same definitions as those defined in Structure (III).

9. The composition according to claim 1, wherein the composition comprises one or more β,β-diaryl-α-cyanoacrylate-based light stabilizers in an amount of no more than 10% by weight, based on total weight of the adhesive composition.

10. The composition according to claim 1, further comprising one or more additional components selected from acid stabilizer compounds, accelerators, thickeners, thermal degradation inhibitors, plasticizers, fillers, opacifiers, surface-insensitive additives, toughening agents, inhibitors, thixotropy conferring agents, and dyes.

11. Cured product of the composition according to claim 1.

12. A method of bonding together two substrates, the method including applying the cyanoacrylate adhesive composition according to claim 1 to at least one of the substrates and then mating together the substrates.
